(19) United States
(12) Patent Application Publication
(10) Pub. No.: US 2013/0253724 A1
(43) Pub. Date: Sep. 26, 2013

(54) SYSTEM AND METHODS FOR USE IN OPERATING ENERGY CONSUMING DEVICES USING LOAD SHEDDING OVERRIDE SCHEDULES

(71) Applicants: Joshua Blake HUFF, Louisville, KY (US); Michael T. Beverle, Louisville, KY (US); William K. Paul, Louisville, KY (US); Michael F. Finch, Louisville, KY (US)

(72) Inventors: Joshua Blake HUFF, Louisville, KY (US); Michael T. Beverle, Louisville, KY (US); William K. Paul, Louisville, KY (US); Michael F. Finch, Louisville, KY (US)

(21) Appl. No.: 13/427,222

(22) Filed: Mar. 22, 2012

(51) Int. Cl. G06F 1/26

(52) U.S. Cl. 700/296

(57) ABSTRACT

System, method, and computer-executable instructions for use in operating one or more energy consuming devices. A load shedding schedule and a load shedding override schedule that is associated with an energy consuming device are determined The energy consuming device is enabled during any portion of the load shedding schedule that coincides with the load shedding override schedule. The energy consuming device is disabled during any portion of the load shedding schedule that does not coincide with the load shedding override schedule.

### BACKGROUND OF THE INVENTION

The subject matter disclosed herein relates generally to energy consuming device networks and, more specifically, to systems and methods for use in operating one or more energy consuming devices based on a load shedding schedule and a load shedding override schedule.

At least some known energy management devices receive a load shedding schedule from an energy provider. Such an energy management device may enable and/or disable one or more energy consuming devices based on the load shedding schedule. Accordingly, energy use by energy consuming devices may be reduced during periods of elevated energy demand indicated by a load shedding schedule.

In some circumstances, however, the user of an energy consuming device, such as a window-mounted air conditioning unit, may wish to operate the device regardless of the load shedding schedule. The user may defeat the load shedding response feature by, for example, configuring the energy management device and/or the energy consuming device to disregard the load shedding schedule. However, such actions prevent the energy consuming device from responding to a load shedding schedule until the energy management device and/or the energy consuming device is re-configured, inconveniencing the user by requiring additional manual configuration. Such inconvenience may be exacerbated when multiple energy consuming devices must be manually configured. Further, manual configuration may not allow a user to fully achieve a desired system behavior, such as operating an energy consuming device based on the load shedding schedule in the morning and disregarding the load shedding schedule in the afternoon, especially if the user is not physically present between such periods.

### BRIEF DESCRIPTION OF THE INVENTION

In one aspect, a system to operate one or more energy consuming devices is provided. The system includes a memory device and a processor coupled with the memory device. The memory device is configured to store a plurality of computer-executable instructions, data indicative of a load shedding schedule representing one or more periods of elevated energy demand, and data indicative of a load shedding override schedule associated with an energy consuming device. The processor is configured to read and execute the computer-executable instructions, and to access the data indicative of the load shedding schedule and/or the data indicative of the load shedding override schedule. When the computer-executable instructions are executed by the processor, the processor is programmed to enable the one or more energy consuming devices during any portion of the load shedding schedule that coincides with the load shedding override schedule, and to disable the one or more energy consuming devices during any portion of the load shedding schedule that does not coincide with the load shedding override schedule.

In another aspect, a method for use in operating one or more energy consuming devices is provided. The method includes receiving, by a computing device, a load shedding schedule representing one or more periods of elevated energy demand. The computing device also receives a load shedding override schedule associated with an energy consuming device. The computing device enables the energy consuming device during any portion of the load shedding schedule that coincides with the load shedding override schedule, and disables the energy consuming device during any portion of the load shedding schedule that does not coincide with the load shedding override schedule.

In yet another aspect, one or more non-transitory computer-readable storage media having computer-executable instructions embodied thereon are provided. When executed by a processor, the computer-executable instructions cause the processor to determine a load shedding schedule representing one or more periods of elevated energy demand, to determine a load shedding override schedule associated with an energy consuming device, to compare the load shedding schedule with the load shedding override schedule, to enable the energy consuming device during any portion of the load shedding schedule that coincides with the load shedding override schedule, and to disable the energy consuming device during any portion of the load shedding schedule that does not coincide with the load shedding override schedule.

### BRIEF DESCRIPTION OF THE DRAWINGS

FIGS. 1-3 show exemplary embodiments of the system and methods described herein.

FIG. 1 is a block diagram of an exemplary computing device that may be used to communicate with an energy management device;

FIG. 2 is block diagram of an exemplary system that includes an energy management device coupled in communication with an energy service interface and a user device by a network; and

FIG. 3 is a flowchart of an exemplary method that may be used in operating the energy consuming devices shown in FIG. 2 using the energy management device shown in FIG. 2.

### DETAILED DESCRIPTION OF THE INVENTION

The embodiments described herein facilitate automatically disabling energy consuming devices according to a load shedding schedule except during periods defined by a user-provided override schedule. In exemplary embodiments, an energy management device receives a load shedding schedule representing periods of elevated energy demand from an energy provider. The energy management device provides a load shedding response feature, generally disabling one or more energy consuming devices during such load shedding periods.

A user may opt out of the load shedding response by providing to the energy management device one or more load shedding override schedules, each of which indicates one or more periods during which the energy consuming device(s) is/are not to be disabled. For example, the user may override load shedding with respect to all devices for several hours while the user is entertaining guests. As another example, the user may override the load shedding response with respect to a single device, such as an air conditioning unit, during a recurring period corresponding to the times at which the user is typically at home each day.

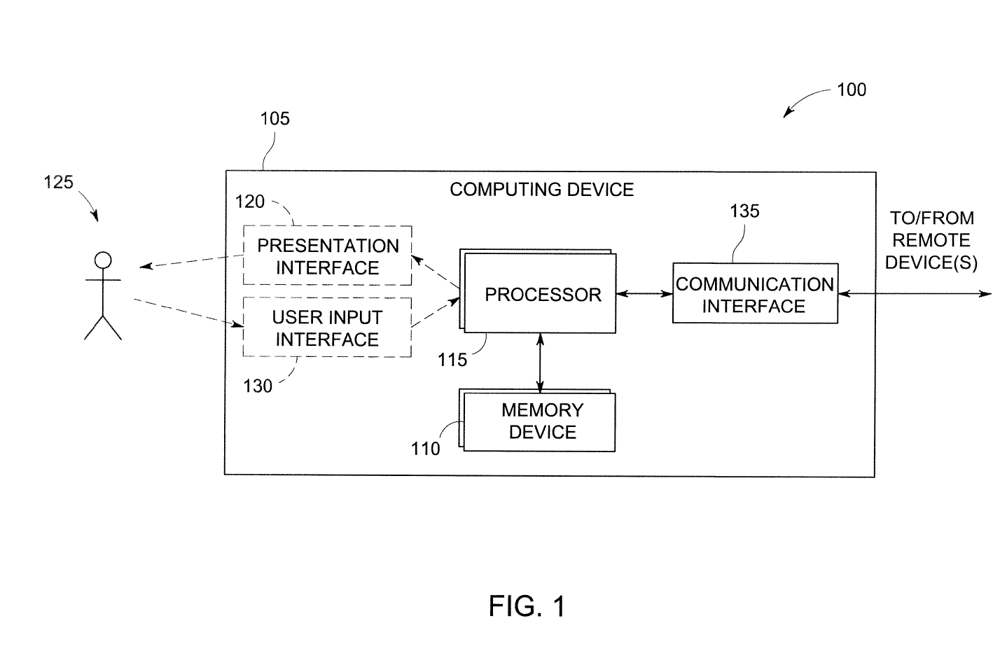

FIG. 1 is a block diagram of an exemplary system 100 with a computing device 105, such as a user device, an energy management device, and/or an energy service interface, that includes a memory device 110 and that may be used to communicate with an energy management device. Computing device 105 includes a processor 115 coupled to memory device 110 for executing programmed instructions. Processor 115 may include, but is not limited to, a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. Processor 115 may include one or more processing units (e.g., in a multi-core configuration). The above examples are exemplary only, and thus are not intended to limit in any way the definition and/or meaning of the term processor.

Memory device 110 is one or more devices allowing information such as executable instructions and/or other data to be stored and retrieved. Memory device 110 may include one or more non-transitory computer readable media, such as, without limitation, dynamic random access memory (DRAM), static random access memory (SRAM), a solid state disk, and/or a hard disk. Memory device 110 may be configured to store, without limitation, executable instructions and/or any other type of data suitable for use with the methods described herein.

Computing device 105 is programmable to perform one or more operations described herein by programming processor 115. For example, processor 115 may be programmed by encoding an operation as one or more executable instructions and embodying the executable instructions in a non-transitory computer readable medium, including, without limitation, a storage device and/or a memory device (e.g., memory device 110). Such instructions, when executed by a processor, cause the processor to perform at least a portion of the methods described herein.

In the exemplary embodiment, computing device 105 includes a presentation interface 120 coupled to processor 115. Presentation interface 120 is configured to output (e.g., display, print, and/or otherwise output) information, such as, but not limited to, utility equipment information, available utility capacities, desired amounts of a utility, and/or fault conditions, to a user 125. For example, presentation interface 120 may include a display adapter (not shown in FIG. 1) that is coupled to a display device, such as a cathode ray tube (CRT), a liquid crystal display (LCD), an organic LED (OLED) display, and/or an “electronic ink” display. In some embodiments, presentation interface 120 includes more than one display device. In addition, or in the alternative, presentation interface 120 may include a printer.

In some embodiments, computing device 105 includes a user input interface 130 that receives input from user 125. For example, user input interface 130 may be configured to receive load shedding override schedules, associations of energy consuming devices with load shedding override schedules, and/or any other information suitable for use with the methods and systems described herein.

In exemplary embodiments, user input interface 130 is coupled to processor 115 and may include, for example, a keyboard, a pointing device, a mouse, a stylus, a touch sensitive panel (e.g., a touch pad or a touch screen), an accelerometer, a position detector, and/or an audio user input interface. A single component, such as a touch screen, may function as both a display device of presentation interface 120 and as user input interface 130.

In exemplary embodiments, computing device 105 includes a communication interface 135 that is coupled to processor 115. Communication interface 135 is coupled in communication with a remote device, such as another computing device 105. For example, communication interface 135 may include, without limitation, a wired network adapter, a wireless network adapter, and/or a mobile telecommunications adapter. In some embodiments, communication interface 135 is configured to receive data that are input by a user at a remote device (e.g., using a user input interface 130 of a remote computing device 105) and transmitted by the remote device. Accordingly, both user input interface 130 and communication interface 135 may be referred to as input interfaces.

In an exemplary embodiment, computing device 105 stores in memory device 110, and/or is operable to access using communication interface 135 (e.g., from another device similar to computing device 105), data for use in communicating with energy consuming devices. For example, such data may include and/or be indicative of load shedding schedules, load shedding override schedules, identifiers and/or network addresses associated with computing devices, and/or any other data suitable for use with the methods described herein.

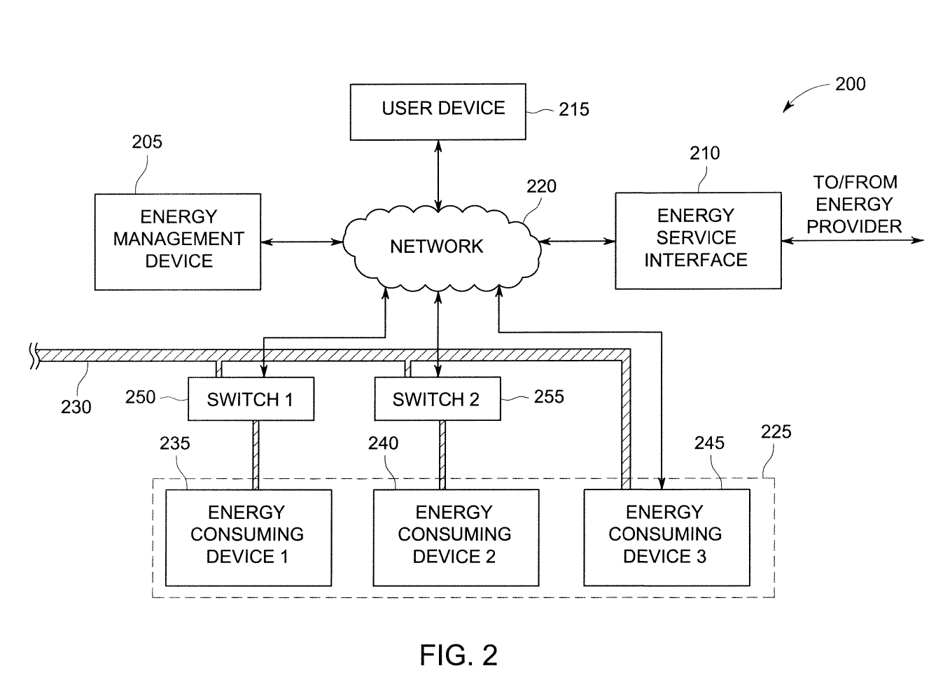

FIG. 2 is block diagram of an exemplary system 200 that includes an energy management device 205 coupled in communication with an energy service interface 210 and a user device 215 by a network 220. In exemplary embodiments, energy management device 205 receives energy information, such as load shedding schedules, from energy service interface 210, which is coupled in communication with an energy provider system (not shown). Energy service interface 210 may be a discrete computing device 105 (shown in FIG. 1) or, alternatively, may be integrated with another device, such as smart meter (not shown), energy management device 205, and/or user device 215.

In exemplary embodiments, energy management device 205 monitors and/or controls a plurality of energy consuming devices 225 that are selectively coupled with an energy source 230. For example, energy management device 205 may monitor energy consumption by energy consuming devices 225, control whether energy is supplied to energy consuming devices 225, and/or instruct energy consuming devices 225 to enable and/or disable themselves, either individually or collectively. A first energy consuming device 235, a second energy consuming device 240, and a third energy consuming device 245 are shown in FIG. 2. However, it is contemplated that system 200 may include any quantity of energy consuming devices 225, such as appliances, climate control devices, lighting devices, pumps, alarm systems, and/or any other device capable of consuming energy.

In exemplary embodiments, energy management device 205, energy service interface 210, user device 215, switches 250 and 255, and/or energy consuming devices 225 are and/or include computing devices 105 that are configured to communicate with each other using a communication interface 135 (shown in FIG. 1). While certain operations are described below with respect to particular devices, it is contemplated that any computing device 105 may perform any of the described operations. Network 220 may include, without limitation, a local area network (LAN), a wireless LAN (WLAN), a home area network (HAN), and/or a mesh network.

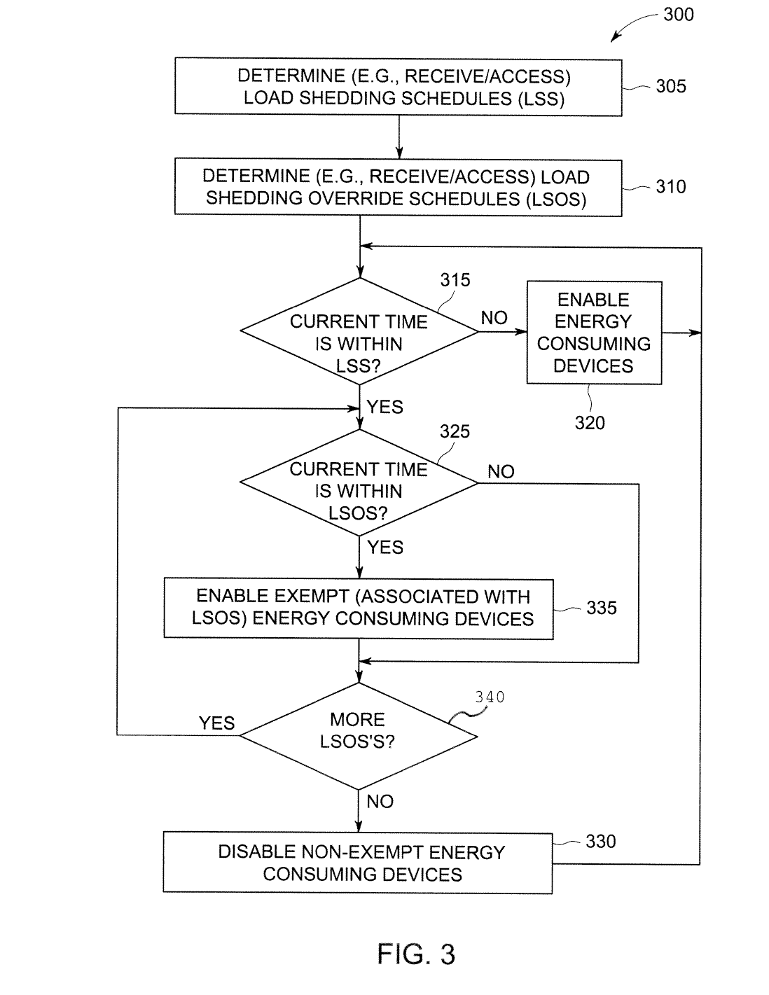

FIG. 3 is a flowchart of an exemplary method 300 that may be used in operating energy consuming devices 225 using energy management device 205 (both shown in FIG. 2). Referring to FIGS. 2 and 3, in exemplary embodiments, energy management device 205 determines 305 one or more load shedding schedules. This determination is accomplished in some embodiments, by the energy management device 205 receiving a load shedding schedule outputted from energy service interface 210 and storing the load shedding schedule in memory device 110 (shown in FIG. 1), from which the load shedding schedule may be accessed subsequently. The load shedding schedule may be included in demand response data that an energy provider outputs to energy service interface 210

Load shedding schedules represent one or more periods, either single or recurring, of elevated energy demand. As an example, during hot weather, energy demand may be elevated each afternoon due to widespread use of cooling systems. In some scenarios, an energy user may significantly reduce total energy cost by reducing energy consumption during such elevated demand periods and, optionally, shifting such energy consumption to other periods. For example, the per-unit cost of energy may be greater during elevated demand periods than during other periods. In addition, or alternatively, the energy provider may provide financial incentives for participating in load shedding during elevated demand periods.

Energy management device 205 also determines 310 (e.g., receives and/or accesses) one or more load shedding override schedules. This determination is accomplished in some embodiments by energy management device 205 receiving a load shedding schedule from an input interface (e.g., user input interface 130 and/or communication interface 135, shown in FIG. 1) and storing the load shedding override schedule in memory device 110, from which the load shedding override schedule may be accessed subsequently. In exemplary embodiments, user device 215 receives a load shedding override schedule outputted from user input interface 130 and transmits the load shedding override schedule to energy management device 205 through network 220. A user may input the load shedding override schedule into user device 215 via the user input interface 130.

Load shedding override schedules are associated with one or more energy consuming devices 225. For example, a load shedding override schedule may be associated with only a single energy consuming device 225 (e.g., first energy consuming device 235), a plurality of specific energy consuming devices 225 (e.g., first energy consuming device 235 and second energy consuming device 240), or all energy consuming devices 225 that energy management device 205 is capable of disabling and enabling.

A load shedding override schedule includes one or more single periods of time and/or one or more recurring periods of time. A single period of time includes a start time and an end time, such as, but not limited to: 6:00 p.m. to 11:00 p.m. on 1 Dec. 2011, or 9:00 a.m. on 22 Nov. 2011 to 2:00 p.m. on 27 Nov. 2011. A recurring period of time includes, for example, a start time, an end time, a recurrence frequency, and, optionally, a recurrence start time and/or a recurrence end time. The recurrence frequency indicates on which dates the recurring period is effective. For example, a recurrence frequency may include, without limitation, every day, one or more specific days of every week, every weekday, one or more specific days of every month, and/or one or more specific days of every year.

In some embodiments, energy management device 205 receives outputs from user interface 130 that associate an identifier (e.g., a name) with one or more of the energy consuming devices 225, switches 250 and 255, and/or load shedding override schedules. For example, first energy consuming device 235 may be associated with the name “Bedroom A/C” to indicate an air conditioning unit in a bedroom, and second energy consuming device 240 may be associated with the name “Pool pump” to indicate a filtration pump for a swimming pool. Similarly, a load shedding override schedule may be associated with a name such as “Workday” or “Birthday party,” such that the association between energy consuming devices 225 and events represented by override schedules is apparent to a user. An exemplary list of load shedding override schedules and associated energy consuming devices 225 is shown in Table 1 below.

TABLE 1

| Override Schedule | Devices | When |
|---|---|---|
| Workday | Bedroom A/C, | 4:00 p.m.-6:00 p.m. |
| | Entry lights | Every Mon-Fri |
| Birthday party | All | 6:00 p.m.-11:00 p.m. |
| | | Thu, 1 Dec 2011 |

In some embodiments, a list such as that shown in Table 1 may be output by the energy management device 205 to the user interface 130. The energy management device 205 may receive data from the user interface 130 indicative of edits made to the list by a user. In exemplary embodiments, the user views such a list using a client application and/or a web browser executed by user device 215, which exchanges load shedding override schedule data with energy management device 205.

Energy management device 205 is operatively coupled with one or more energy consuming devices 225, either directly or indirectly, such that energy management device 205 is operable to adjust the power consumption of, disable, and/or enable energy consuming devices 225 based on load shedding schedules and load shedding override schedules.

In the example shown in FIG. 2, first energy consuming device 235 is associated with a first switch 250 that selectively couples first energy consuming device 235 with energy source 230 in response to a signal outputted from the energy management device 205. Second energy consuming device 240 is associated with a second switch 255 that selectively couples second energy consuming device 240 with energy source 230 in response to a signal outputted from the energy management device 205. The signal outputted from the energy management device 205 to the switches 250, 255 produces a tangible, physical result—e.g., the opening or closing of the switches 250, 255, each of which is a physical apparatus—and is both different and derived from other data and/or signals received by and/or processed by the energy management device 205. Further, opening or closing the switches 250, 255 produces another physical result by preventing or allowing, respectively, the flow of energy to energy consuming devices 235, 240, as described below.

Energy management device 205 is operatively coupled with first switch 250 and second switch 255. In exemplary embodiments, energy management device 205 disables first energy consuming device 235 by opening first switch 250, which decouples first energy consuming device 235 from energy source 230, preventing the flow of electrical energy from energy source 230 to first energy consuming device 235. Similarly, energy management device 205 enables first energy consuming device 235 by closing first switch 250, which couples first energy consuming device 235 with energy source 230, allowing the flow of electrical energy from energy source 230 to first energy consuming device 235. In some embodiments, first switch 250 includes a computing device 105, and energy management device 205 operates first switch 250 by transmitting commands (e.g., a disable command and/or an enable command) to first switch 250. In other embodiments, first switch 250 includes a relay, and energy management device 205 operates first switch 250 by actuating the relay. Other methods of operating switches are also contemplated.

As shown in FIG. 2, energy management device 205 is directly coupled with third energy consuming device 245, which is capable of enabling and disabling itself. Energy management device 205 disables third energy consuming device 245 by transmitting a disable command to third energy consuming device 245 and enables third energy consuming device 245 by transmitting an enable command to third energy consuming device 245. In response to such commands, third energy consuming device 245 configures itself to operate in a power state corresponding to the received command. For example, in response to a disable command, third energy consuming device 245 enters a low-power or “sleep” state in which the primary function(s) of third energy consuming device 245 are disabled, but in which third energy consuming device 245 remains capable of communicating with energy management device 205, such that an enable command may be received and acted upon. In response to an enable command, third energy consuming device 245 enters a normal state in which the primary functions of third energy consuming device 245 are enabled.

Given a load shedding schedule and a load shedding override schedule that is associated with first energy consuming device 235, energy management device 205 enables first energy consuming device 235 during any portion of the load shedding schedule that coincides with the load shedding override schedule and disables first energy consuming device 235 during any portion of the load shedding schedule that does not coincide with the load shedding override schedule. Similarly, if the load shedding schedule override schedule is also associated with second energy consuming device 240, energy management device 205 enables second energy consuming device 240 during any portion of the load shedding schedule that coincides with the load shedding override schedule and disables second energy consuming device 240 during any portion of the load shedding schedule that does not coincide with the load shedding override schedule.

In exemplary embodiments, energy management device 205 applies load shedding override schedules, as described above, by determining 315 whether the current time is within any load shedding schedule previously determined 305 (e.g., received and/or stored) by energy management device 205. If the current time is not within any load shedding schedule, energy management device 205 enables 320 energy consuming devices 225.

If the current time is within a load shedding schedule, energy management device 205 determines 325 whether the current time is also within any load shedding override schedule. If the current time is not within any load shedding override schedule, no energy consuming devices 225 are exempt from the load shedding schedule, and energy management device 205 disables 330 energy consuming devices 225.

If the current time is within a load shedding override schedule, the energy consuming devices 225 associated with the load shedding override schedule are exempt from the load shedding schedule. Energy management device 205 enables 335 energy consuming devices 225 that are exempt (e.g., first energy consuming device 235) and proceeds to determine 325 whether the current time is within any other load shedding override schedule, as described above. As represented by block 340, the energy management device 205 determines whether there are more load shedding override schedules (LSOS′S). If yes, the method loops back to the block 325. If not, the method proceeds as follows. When energy management device 205 has determined 325 whether the current time is within each load shedding override schedule, energy management device 205 disables 330 all energy consuming devices 225 that are not exempt from the load shedding schedule.

In exemplary embodiments, energy management device 205 repeatedly (e.g., continuously, periodically, and/or upon request) determines 315 whether the current time is within any load shedding schedule and proceeds as described above. Accordingly, as a load shedding schedule becomes ineffective (e.g., the current time is no longer within any period included in the load shedding schedule), energy consuming devices 225 are enabled 320. Further, even if a load shedding schedule is still effective, an energy consuming device 225 that was previously disabled 330 will be enabled 335 when a load shedding override schedule associated with the energy consuming device 225 becomes effective. Such embodiments enable a user to configure energy management device 205 to ensure an air conditioning unit, for example, is enabled 335 before the user expects to arrive from work, while allowing the energy management device 205 to disable 330 the air conditioning unit at other times to lower total energy cost.

In some embodiments, determining 315 whether the current time is within a load shedding schedule and determining 325 whether the current time is within a load shedding override schedule are accomplished at least in part by comparing a load shedding schedule to a load shedding override schedule. For example, an override-adjusted version of the load shedding schedule corresponding to a set of energy consuming devices 225 may be created by subtracting from the load shedding schedule any periods defined by a load shedding override schedule associated with the set of energy consuming devices 225.

Embodiments described herein may be performed using a computer-based or computing-device-based operating environment as described below. A computer or computing device may include one or more processors or processing units, system memory, and some form of non-transitory computer-readable media. Exemplary non-transitory computer-readable media include flash memory drives, hard disk drives, digital versatile discs (DVDs), compact discs (CDs), floppy disks, and tape cassettes. By way of example and not limitation, computer-readable media comprise computer storage media and communication media. Computer-readable storage media are non-transitory and store information such as computer-readable instructions, data structures, program modules, or other data. Communication media typically embody computer-readable instructions, data structures, program modules, or other data in a modulated data signal such as a carrier wave or other transport mechanism and include any information delivery media. Combinations of any of the above are also included within the scope of computer-readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when that general-purpose computer reads and/or executes the computer-readable instructions described herein.

The system and methods described herein are not limited to the specific embodiments described herein. For example, components of each system and/or steps of each method may be used and/or practiced independently and separately from other components and/or steps described herein. In addition, each component and/or step may also be used and/or practiced with other apparatus and methods.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the invention has been described in terms of various specific embodiments, those skilled in the art will recognize that the invention may be practiced with modification within the spirit and scope of the claims.

What is claimed is:

1. A system to operate one or more energy consuming devices, said system comprising:
a memory device configured to store:
a plurality of computer-executable instructions;
data indicative of a load shedding schedule representing one or more periods of elevated energy demand; and
data indicative of a load shedding override schedule associated with an energy consuming device; and
a processor coupled with said memory device and configured to read and execute the computer-executable instructions and to access at least one of the data indicative of the load shedding schedule and the data indicative of the load shedding override schedule, wherein when the computer-executable instructions are executed by the processor, the processor is programmed to:
enable the one or more energy consuming devices during any portion of the load shedding schedule that coincides with the load shedding override schedule; and
disable the one or more energy consuming devices during any portion of the load shedding schedule that does not coincide with the load shedding override schedule.

2. A system according to claim 1, wherein the load shedding override schedule of said memory device includes a single period of time.

3. A system according to claim 1, wherein the load shedding override schedule of said memory device includes a recurring period of time.

4. A system according to claim 1, wherein said processor is programmed to:
enable the energy consuming device by closing a switch associated with the energy consuming device; and
disable the energy consuming device by opening a switch associated with the energy consuming device.

5. A system according to claim 1, wherein said processor is programmed to:
enable the energy consuming device by transmitting an enable command to the energy consuming device using said communication interface; and
disable the energy consuming device by transmitting a disable command to the energy consuming device using said communication interface.

6. A system according to claim 1, further comprising an input interface coupled with said processor and configured to receive the load shedding override schedule from a user.

7. A system according to claim 6, wherein the energy consuming device is a first energy consuming device of a plurality of energy consuming devices, and said input interface is configured to receive the load shedding override schedule by receiving a load shedding override schedule associated with only the first energy consuming device.

8. A system according to claim 6, wherein the energy consuming device is a first energy consuming device of a plurality of energy consuming devices, said input interface is configured to receive the load shedding override schedule by receiving a load shedding override schedule associated with the plurality of energy consuming devices, and said processor is further programmed to:
enable a second energy consuming device of the plurality of energy consuming devices during any portion of the load shedding schedule that coincides with the load shedding override schedule; and
disable the second energy consuming device during any portion of the load shedding schedule that does not coincide with the load shedding override schedule.

9. A system according to claim 1, further comprising a communication interface coupled with said processor and configured to receive the load shedding schedule from an energy provider, wherein said processor is further programmed to store the received load shedding schedule in said memory device.

10. A method for use in operating one or more energy consuming devices, said method comprising:
receiving, by a computing device, a load shedding schedule representing one or more periods of elevated energy demand;
receiving, by the computing device, a load shedding override schedule associated with an energy consuming device;
enabling, by the computing device, the energy consuming device during any portion of the load shedding schedule that coincides with the load shedding override schedule; and
disabling, by the computing device, the energy consuming device during any portion of the load shedding schedule that does not coincide with the load shedding override schedule.

11. A method according to claim 10, wherein enabling the energy consuming device comprises closing a switch associated with the energy consuming device.

12. A method according to claim 10, wherein enabling the energy consuming device comprises transmitting an enable command to the energy consuming device.

13. A method according to claim 10, wherein the energy consuming device is a first energy consuming device of a plurality of energy consuming devices, and receiving the load shedding override schedule comprises receiving a load shedding override schedule associated with only the first energy consuming device.

14. A method according to claim 10, wherein the energy consuming device is a first energy consuming device of a plurality of energy consuming devices, and receiving the load shedding override schedule comprises receiving a load shedding override schedule associated with the plurality of energy consuming devices.

15. One or more non-transitory computer-readable storage media having computer-executable instructions embodied thereon, wherein when executed by a processor, the computer-executable instructions cause the processor to:
determine a load shedding schedule representing one or more periods of elevated energy demand;
determine a load shedding override schedule associated with an energy consuming device;
compare the load shedding schedule with the load shedding override schedule;
enable the energy consuming device during any portion of the load shedding schedule that coincides with the load shedding override schedule; and
disable the energy consuming device during any portion of the load shedding schedule that does not coincide with the load shedding override schedule.

16. One or more non-transitory computer-readable storage media according to claim 15, wherein the computer-executable instructions cause the processor to determine a load shedding override schedule by accessing, from a memory device, a load shedding override schedule that includes a single period of time.

17. One or more non-transitory computer-readable storage media according to claim 15, wherein the computer-executable instructions cause the processor to determine a load shedding override schedule by accessing, from a memory device, a load shedding override schedule that includes a recurring period of time.

18. One or more non-transitory computer-readable storage media according to claim 15, wherein the computer-executable instructions cause the processor to enable the energy consuming device by at least one of closing a switch associated with the energy consuming device, and transmitting an enable command to the energy consuming device.

19. One or more non-transitory computer-readable storage media according to claim 15, wherein the energy consuming device is a first energy consuming device of a plurality of energy consuming devices, and the computer-executable instructions cause the processor to determine the load shedding override schedule by receiving a load shedding override schedule associated with only the first energy consuming device.

20. One or more non-transitory computer-readable storage media according to claim 15, wherein the energy consuming device is a first energy consuming device of a plurality of energy consuming devices, and the computer-executable instructions cause the processor to:
determine the load shedding override schedule by receiving, from a user interface, a load shedding override schedule associated with the plurality of energy consuming devices.
